(19) United States
(12) Patent Application Publication
(10) Pub. No.: US 2018/0264735 A1
(43) Pub. Date: Sep. 20, 2018

(54) GENERATING THREE-DIMENSIONAL OBJECTS

(71) Applicant: HEWLETT-PACKARD DEVELOPMENT COMPANY, L.P., Houston, TX (US)

(72) Inventors: Xavier Vilajosana, Sant Cugat del Valles (ES); Sebastia Cortes, Barcelona (ES); Alejandro Manuel De Pena, Sant Cugat del Valles (ES)

(73) Assignee: HEWLETT-PACKARD DEVELOPMENT COMPANY, L.P., Houston, TX (US)

(21) Appl. No.: 15/542,285

(22) PCT Filed: Apr. 17, 2015
(86) PCT No.: PCT/US2015/026355

§ 371 Date: Jul. 7, 2017

(51) Int. Cl. B29C 64/393; B33Y 30/00; B33Y 50/02; B33Y 10/00; B29C 64/188; B29C 64/165; B28B 1/00; B28B 17/00; B22F 3/105; C03B 19/01

(52) U.S. Cl. CPC B29C 64/393; B33Y 30/00; B33Y 50/02; B33Y 10/00; C03B 19/01; B29C 64/165; B28B 1/001; B28B 17/0081; B22F 3/1055; B29C 64/188

(57) ABSTRACT

A sensor may be to detect a height profile of build material for generating the three-dimensional object. A defect of the build material may be determined to exist based on the height profile of the build material. The defect may be corrected or the defect may be prevented from impacting a component of the system. A portion of a layer of the build material delivered by a build material distributor may be selectively solidified.

### BACKGROUND

Additive manufacturing systems that generate three-dimensional objects on a layer-by-layer basis have been proposed as a potentially convenient way to produce three-dimensional objects. The quality of objects produced by such systems may vary widely depending on the type of additive manufacturing technology used.

### BRIEF DESCRIPTION

Some examples are described with respect to the following figures:

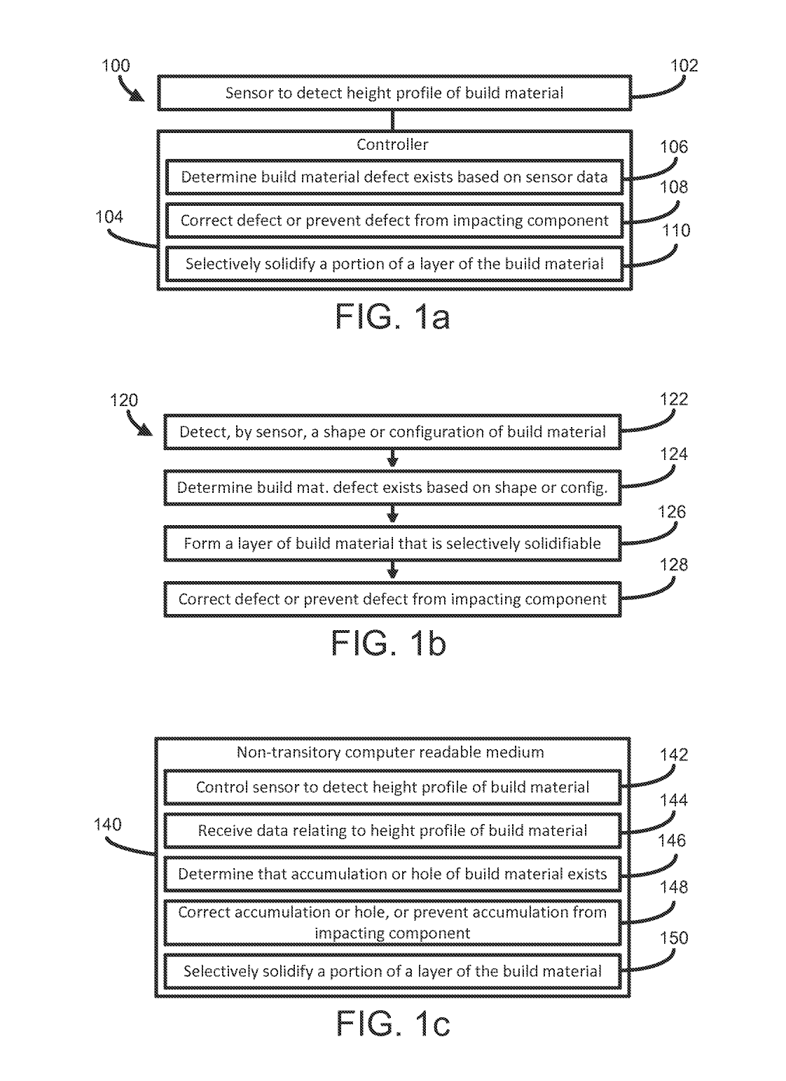

FIG. 1a illustrates a system for generating a three-dimensional object according to some examples;

FIG. 1b is a flow diagram illustrating a method according to some examples;

FIG. 1c is a block diagram illustrating a non-transitory computer readable storage medium according to some examples;

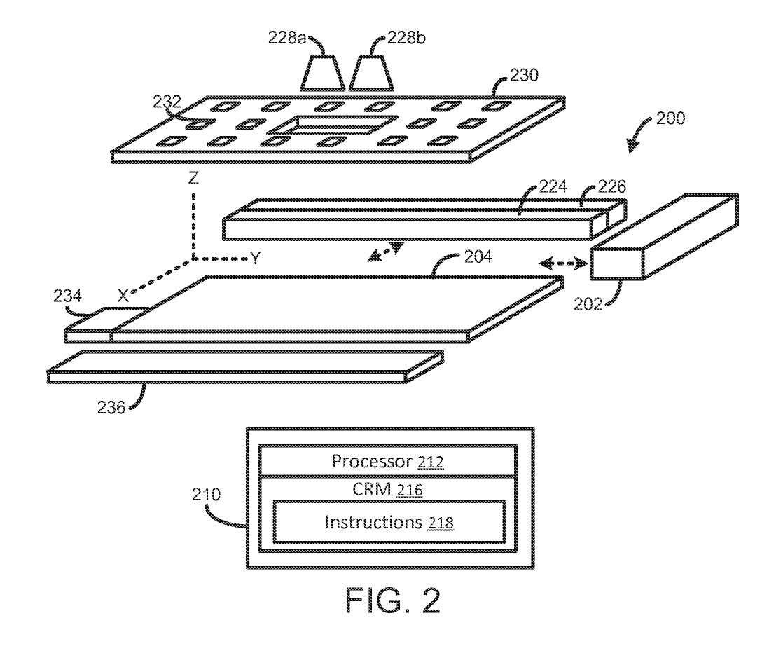

FIG. 2 is a simplified isometric illustration of an additive manufacturing system according to some examples;

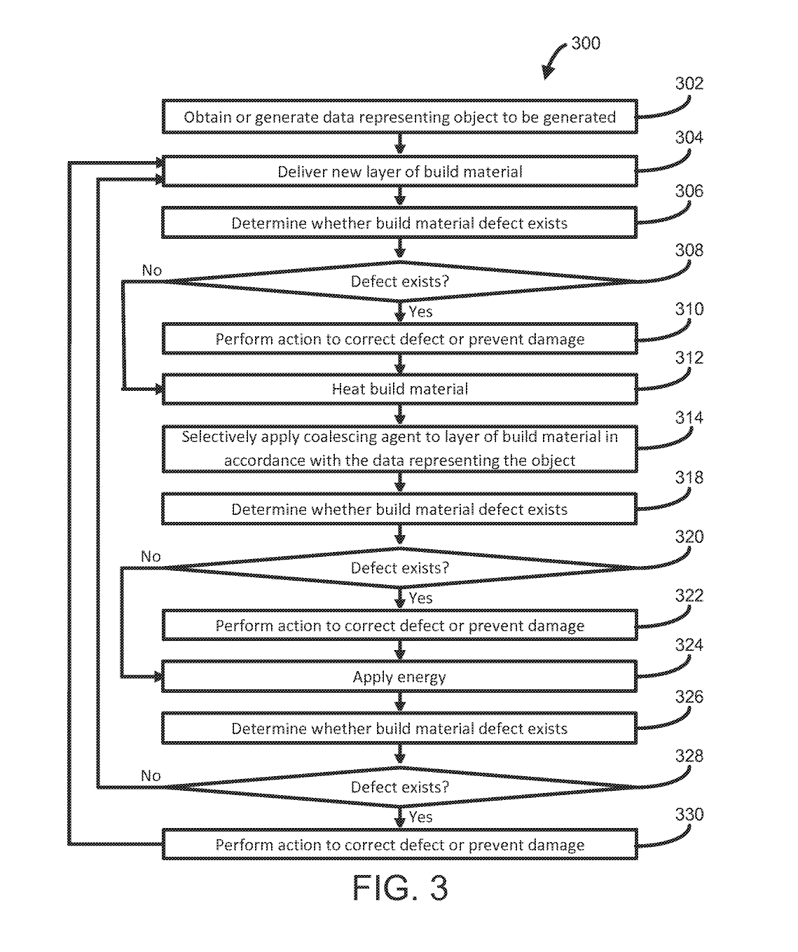

FIG. 3 is a flow diagram illustrating a method of generating a three-dimensional object according to some examples;

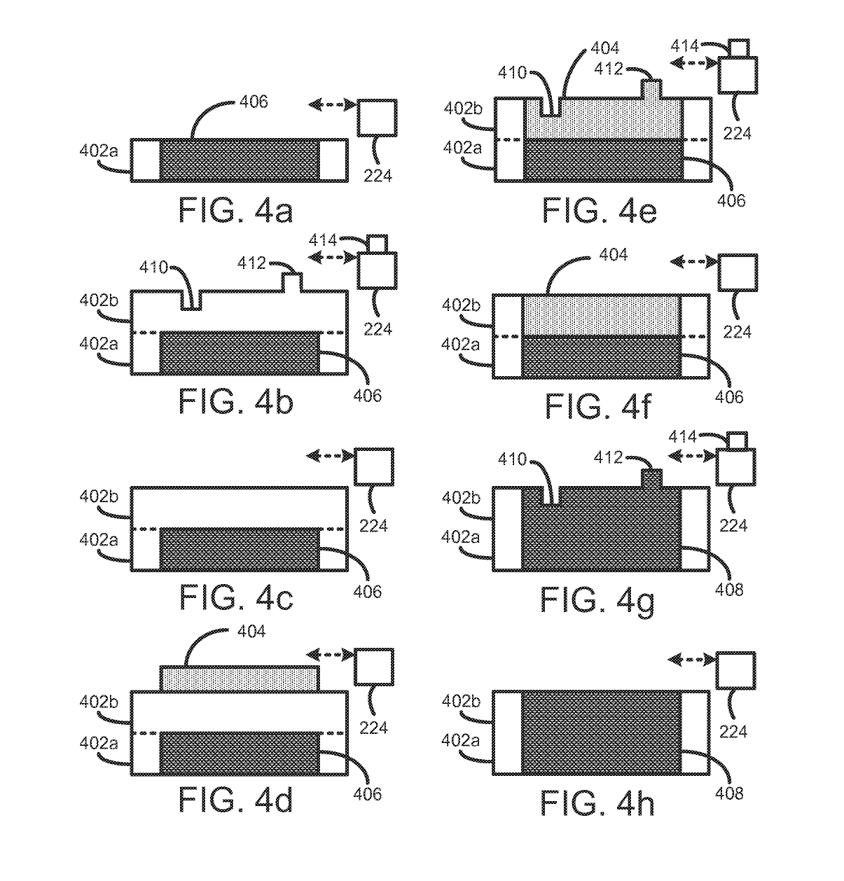

FIGS. 4a-h show a series of cross-sectional side views of layers of build material according to some examples; and

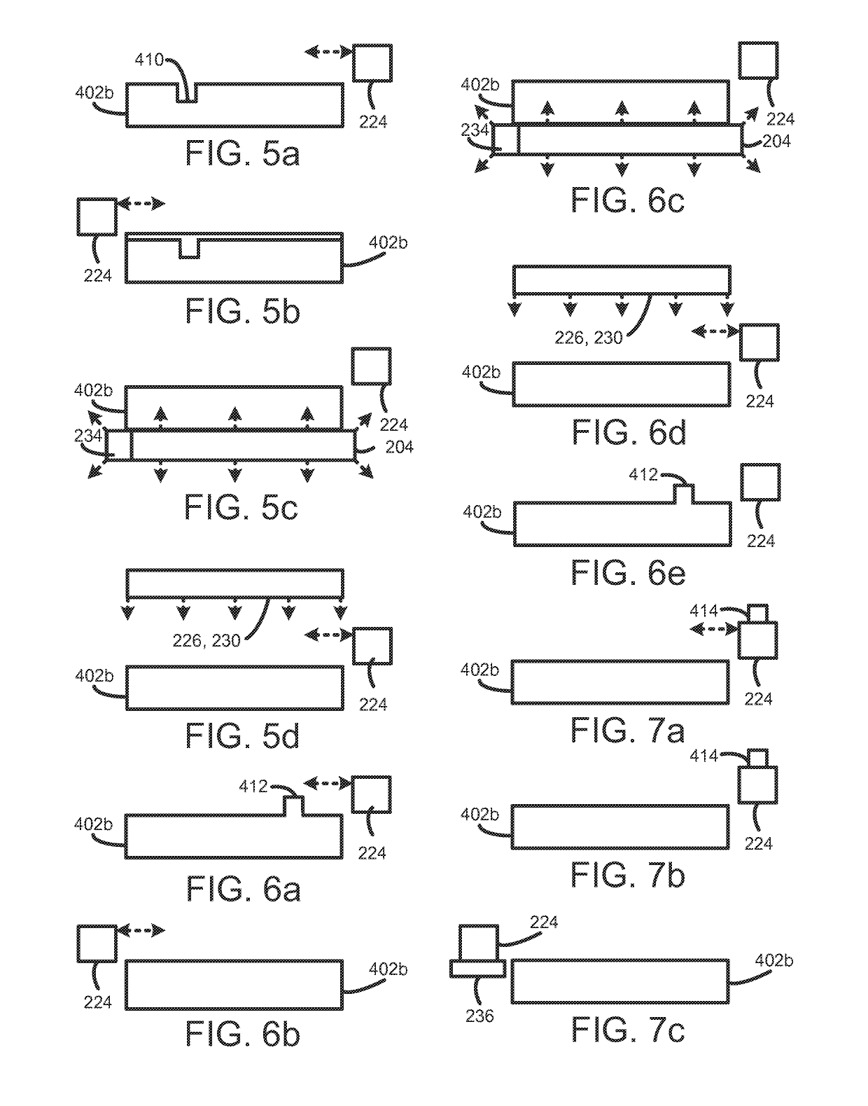

FIGS. 5a-d, 6a-e, and 7a-c show a series of cross-sectional side views of layers of build material and build material distributors in which corrective actions are performed according to some examples.

### DETAILED DESCRIPTION

The following terminology is understood to mean the following when recited by the specification or the claims. The singular forms “a,” “an,” and “the” mean “one or more.” The terms “including” and “having” are intended to have the same inclusive meaning as the term “comprising.”

Some additive manufacturing systems generate three-dimensional objects through the solidification of portions of successive layers of build material, such as a powdered, liquid, or fluidic build material. The properties of generated objects may be dependent on the type of build material and the type of solidification mechanism used. In some examples, solidification may be achieved using a binder agent which binds and solidifies build material into a binder matrix, which is a mixture of generally separate particles or masses of build material that are adhesively bound together by a binder agent. In other examples, solidification may be achieved by temporary application of energy to the build material. This may, for example, involve use of a coalescing agent, which is a material that, when a suitable amount of energy is applied to a combination of build material and coalescing agent, may cause the build material to coalesce and solidify. In some examples, a multiple agent additive manufacturing system may be used such as that described in PCT Application No. PCT/EP2014/050841 filed on Jan. 16, 2014, entitled “GENERATING A THREE-DIMENSIONAL OBJECT”, the entire contents of which are hereby incorporated herein by reference. For example, in addition to selectively delivering coalescing agent to layers build material, coalescence modifier agent may also be selectively delivered to layers of build material. A coalescence modifier agent may serve to modify the degree of coalescence of a portion of build material on which the coalescence modifier agent has been delivered or has penetrated. In yet other examples, other methods of solidification may be used, for example selective laser sintering (SLS), light polymerization, among others. The examples described herein may be used with any of the above additive manufacturing systems and suitable adaptations thereof.

In some examples, build material may experience a defect, e.g. during the build process. Build material experiencing a defect means that the build material has an unintended configuration or shape. For example, the build material in a delivered layer may include an accumulation (e.g. a presence of build material in a volume not intended to include build material) or a hole (e.g. an absence of build material in a volume intended to include build material), or the build material distributor may include an accumulation of build material. Accordingly, the present disclosure provides examples for correcting a defect or preventing a component of the system from impacting a defect.

FIG. 1a is a block diagram illustrating a system 100 of generating a three-dimensional object according to some examples. A sensor 102 may be to detect a height profile of build material for generating the three-dimensional object. A controller 104 may be to determine 106 that a defect of the build material exists based on data received from the sensor and relating to the height profile of the build material. The controller may be to instruct 108 the system to correct the defect or to prevent the defect from impacting a component of the system. The controller may be to control 110 the system to selectively solidify a portion of a layer of the build material delivered by a build material distributor.

FIG. 1b is a flow diagram illustrating a method 120 according to some examples. At 122, a sensor may detect a shape or configuration of build material for generating a three-dimensional object. At 124, a controller may determine that a defect of the build material exists based on the detected shape or configuration of the build material. At 126, a build material distributor may deliver a layer of build material. The layer of build material may be selectively solidifiable by delivery of agent or by application of energy thereto. At 128, the defect may be corrected or prevented from impacting a component of the system.

FIG. 1c is a block diagram illustrating a non-transitory computer readable storage medium 140 according to some examples. The non-transitory computer readable medium 140 may include executable instructions 142 that, when executed by a processor, may cause the processor to control a ranging sensor to detect a height profile of build material for generating a three-dimensional object. The non-transitory computer readable medium 140 may include executable instructions 144 that, when executed by a processor, may cause the processor to receive data relating to the detected height profile of the build material from the ranging sensor. The non-transitory computer readable medium 140 may include executable instructions 146 that, when executed by a processor, may cause the processor to, based on the received data, determine that the build material includes an accumulation or a hole. The non-transitory computer readable medium 140 may include executable instructions 148 that, when executed by a processor, may cause the processor to control a system for generating the three-dimensional object to correct the accumulation or the hole or control the system to prevent the accumulation from impacting a component of the system. The non-transitory computer readable medium 140 may include executable instructions 150 that, when executed by a processor, may cause the processor to control the system to selectively solidify a portion of a layer of the build material delivered by a build material distributor.

FIG. 2 is a simplified isometric illustration of an additive manufacturing system 200 according to some examples. The system 200 may be operated, as described further below with reference to the flow diagram of FIG. 3 to generate a three-dimensional object.

In some examples the build material may be a powder-based build material. As used herein the term powder-based materials is intended to encompass both dry and wet powder-based materials, particulate materials, granular, and fluidic materials. In some examples, the build material may include a mixture of air and solid polymer particles, for example at a ratio of about 40% air and about 60% solid polymer particles. One suitable material may be Nylon 12, which is available, for example, from Sigma-Aldrich Co. LLC. Another suitable Nylon 12 material may be PA 2200 which is available from Electro Optical Systems EOS GmbH. Other examples of suitable build materials may include, for example, powdered metal materials, powdered composite materials, powdered ceramic materials, powdered glass materials, powdered resin material, powdered polymer materials, and the like, arid combinations thereof. It should be understood, however, that the examples described herein are not limited to powder-based materials or to any of the materials listed above. In other examples the build material may be in the form of a paste, liquid or a gel. According to one example a suitable build material may be a powdered semi-crystalline thermoplastic material.

The additive manufacturing system 200 may include a system controller 210. Any of the operations and methods disclosed herein (e.g. in FIG. 3) may be implemented and controlled in the additive manufacturing system 200 and/or controller 210. The controller 210, as understood herein, comprises (1) a non-transitory computer-readable storage medium comprising instructions to perform operations and methods disclosed herein, and a processor coupled to the non-transitory computer-readable storage medium to execute the instructions or (2) circuitry to perform the operations and methods disclosed herein.

The controller 210 may include a processor 212 for executing instructions that may implement the methods described herein. The processor 212 may, for example, be a microprocessor, a microcontroller, a programmable gate array, an application specific integrated circuit (ASIC), a computer processor, or the like. The processor 212 may, for example, include multiple cores on a chip, multiple cores across multiple chips, multiple cores across multiple devices, or combinations thereof. In some examples, the processor 212 may include at least one Integrated circuit (IC), other control logic, other electronic circuits, or combinations thereof.

In some examples, the controller 210 may support direct user interaction. For example, the additive manufacturing system 200 may include user input devices coupled to the processor 212, such as a keyboard, touchpad, buttons, keypad, dials, mouse, track-ball, card reader, or other input devices. Additionally, the additive manufacturing system 200 may include output devices coupled to the processor 212, such as a liquid crystal display (LCD), video monitor, touch screen display, a light-emitting diode (LED), or other output devices. The output devices may be responsive to instructions to display textual information or graphical data.

The processor 212 may be in communication with a computer-readable storage medium 216 via a communication bus. The computer-readable storage medium 216 may include a single medium or multiple media. For example, the computer readable storage medium 216 may include one or both of a memory of the ASIC, and a separate memory in the controller 210. The computer readable storage medium 216 may be any electronic, magnetic, optical, or other physical storage device. For example, the computer-readable storage medium 216 may be, for example, random access memory (RAM), static memory, read only memory, an electrically erasable programmable read-only memory (EEPROM), a hard drive, an optical drive, a storage drive, a CD, a DVD, and the like. The computer-readable storage medium 216 may be non-transitory. The computer-readable storage medium 216 may store, encode, or carry computer executable instructions 218 that, when executed by the processor 212, may cause the processor 212 to perform any of the methods or operations disclosed herein according to various examples. In other examples, the controller 210 may not include a computer-readable storage medium 216, and the processor may comprise circuitry to perform any of the methods or operations disclosed herein without executing separate instructions in a computer-readable storage medium.

The system 200 may include a coalescing agent distributor 202 to selectively deliver coalescing agent to successive layers of build material provided on a support member 204. According to one non-limiting example, a suitable coalescing agent may be an ink-type formulation comprising carbon black, such as, for example, the ink formulation commercially known as CM997A available from Hewlett-Packard Company. In one example such an ink may additionally comprise an infra-red light absorber. In one example such an ink may additionally comprise a near infra-red light absorber. In one example such an ink may additionally comprise a visible light absorber. In one example such an ink may additionally comprise a UV light absorber. Examples of inks comprising visible light enhancers are dye based colored ink and pigment based colored ink, such as inks commercially known as CM993A and CE042A available from Hewlett-Packard Company.

The controller 210 may control the selective delivery of coalescing agent to a layer of provided build material in accordance with the instructions 218.

The agent distributor 202 may be a printhead, such as a thermal inkjet printhead or a piezo inkjet printhead. The printhead may have arrays of nozzles. In one example, printheads such as those commonly used in commercially available inkjet printers may be used. In other examples, the agents may be delivered through spray nozzles rather than through printheads. Other delivery mechanisms may be used as well. The agent distributor 202 may be used to selectively deliver, e.g. deposit, coalescing agent when in the form of suitable fluids such as a liquid.

The coalescing agent distributor 202 may include a supply of coalescing agent or may be connectable to a separate supply of coalescing agent.

The agent distributor 202 may be used to selectively deliver, e.g. deposit, coalescing agent when in the form of a suitable fluid such as liquid. In some examples, the agent distributor 202 may have an array of nozzles through which the agent distributor 202 is able to selectively eject drops of fluid. In some examples, each drop may be in the order of about 10 Pico liters (pi) per drop, although in other examples the agent distributor 202 is able to deliver a higher or lower drop size. In some examples the agent distributor 202 is able to deliver variable size drops.

In some examples the coalescing agent may comprise a liquid carrier, such as water or any other suitable solvent or dispersant, to enable it to be delivered via a printhead.

In some examples the printheads may be drop-on-demand printhead. In other examples the printhead may be continuous drop printhead.

In some examples, the agent distributor 202 may be an integral part of the system 200. In some examples, the agent distributor 202 may be user replaceable, in which case they may be removably insertable into a suitable agent distributor receiver or interface module of the system 200.

In the example illustrated in FIG. 2, the agent distributor 202 may have a length that enables it to span the whole width of the support member 204 in a so-called page-wide array configuration. In one example this may be achieved through a suitable arrangement of multiple printheads. In other examples a single printhead having an array of nozzles having a length to enable them to span the width of the support member 204 may be used. In other examples, the agent distributor 202 may have a shorter length that does not enable it to span the whole width of the support member 204.

The agent distributor 202 may be mounted on a moveable carriage to enable it to move bi-directionally across the length of the support 204 along the illustrated y-axis. This enables selective delivery of coalescing agent across the whole width and length of the support 204 in a single pass. In other examples the agent distributor 202 may be fixed, and the support member 204 may move relative to the agent distributor 202.

In other examples the agent distributors may be fixed, and the support member 204 may move relative to the agent distributors.

It should be noted that the term ‘width’ used herein is used to generally denote the shortest dimension in the plane parallel to the x and y axes illustrated in FIG. 2, whilst the term ‘length’ used herein is used to generally denote the longest dimension in this plane. However, it will be understood that in other examples the term ‘width’ may be interchangeable with the term ‘length’. For example, in other examples the agent distributor 202 may have a length that enables them to span the whole length of the support member 204 whilst the moveable carriage may move bi-directionally across the width of the support member 204.

In another example the agent distributor 202 does not have a length that enables it to span the whole width of the support member but are additionally movable bi-directionally across the width of the support member 204 in the illustrated x-axis. This configuration enables selective delivery of coalescing agent across the whole width and length of the support 204 using multiple passes. Other configurations, however, such as a page-wide array configuration, may enable three-dimensional objects to be created faster.

The system 200 may further comprise a build material distributor 224 to provide, e.g. deliver and/or deposit, successive layers of build material on the support member 204. Suitable build material distributors 224 may include, for example, a wiper blade and a roller. Build material may be supplied to the build material distributor 224 from a hopper or build material store. In the example shown the build material distributor 224 moves across the width (x-axis) of the support member 204 to deposit a layer of build material. As previously described, a layer of build material will be deposited on the support member 204, whereas subsequent layers of build material will be deposited on a previously deposited layer of build material. The build material distributor 224 may be a fixed part of the system 200, or may not be a fixed part of the system 200, instead being, for example, a part of a removable module. In some examples, the build material distributor 224 may be mounted on a carriage.

In some examples, the thickness of each layer may have a value selected from the range of between about 50 to about 300 microns, or about 90 to about 110 microns, or about 250 microns, although in other examples thinner or thicker layers of build material may be provided. The thickness may be controlled by the controller 210, for example based on the instructions 218.

In some examples, there may be any number of additional agent distributors and build material distributors relative to the distributors shown in FIG. 2. In some examples, the some distributors of system 200 may be located on the same carriage, either adjacent to each other or separated by a short distance. In other examples, two or more carriages each may contain a distributor. For example, each distributor may be located in its own separate carriage. Any additional distributors may have similar features as those discussed earlier with reference to the coalescing agent distributor 202. However, in some examples, different agent distributors may deliver different coalescing agents and/or coalescence modifier agents, for example.

In the example shown the support 204 is moveable in the z-axis such that as new layers of build material are deposited a predetermined gap is maintained between the surface of the most recently deposited layer of build material and lower surface of the agent distributor 202. In other examples, however, the support 204 may not be movable in the z-axis and the agent distributor 202 may be movable in the z-axis.

In some examples, the system 200 may include a cleaning station 236 for the build material distributor 224. For example, the build material distributor 224 may movable across the x-axis to be stationed at the cleaning station 236 which may include any suitable components for cleaning accumulated build material off of the build material distributor 224. The cleaning station may include automated cleaning components for automatic cleaning, or manual cleaning components for a user to use for manual cleaning. In an example, the cleaning station 236 may include a fabric on which the build material distributor (e.g. a roller) rolls to release an accumulation. In examples, the cleaning station 236 may include brushes, vibrating tools, or any other suitable components.

In some examples, the system 200 may include a leveling tool 234 to cause build material on the support member 204. In some examples, the leveling tool 234 may be to vibrate the support member 204 to cause leveling. In some examples, the leveling tool 234 may be to tilt the support members 204 in cycles of opposing directions until the build material is sufficiently leveled (e.g. the leveling tool 234 may be an Archimedes' screw to cause the tilting). Other types of leveling tools may be used as well.

The system 200 may additionally include an energy source 226 to apply energy to build material to cause the solidification of portions of the build material according to where coalescing agent has been delivered or has penetrated. In some examples, the energy source 226 is an infra-red (IR) radiation source, near infra-red radiation source, halogen radiation source, or a light emitting diode. In some examples, the energy source 226 may be a single energy source that is able to uniformly apply energy to build material deposited on the support 204, In some examples, the energy source 226 may comprise an array of energy sources.

In other examples, the energy source 226 may be to apply energy in a substantially uniform manner to a portion of the whole surface of a layer of build material. For example, the energy source 226 may be to apply energy to a strip of the whole surface of a layer of build material. In these examples, as shown in FIG. 2, the energy source may be moved or scanned across the layer of build material, e.g. along the x-axis, such that a substantially equal amount of energy is ultimately applied across the whole surface of a layer of build material.

In some examples, the energy source 226 may be to apply energy in a substantially uniform manner to the whole surface of a layer of build material. In these examples the energy source 226 may be said to be an unfocused energy source. In these examples, a whole layer may have energy applied thereto simultaneously, which may help increase the speed at which a three-dimensional object may be generated.

In some examples, the energy source 226 may be mounted on the moveable carriage, for example the same carriage on which the build material distributor 224 is mounted.

In other examples, the energy source 226 may apply a variable amount of energy as it is moved across the layer of build material, for example in accordance with instructions 218, For example, the controller 210 may control the energy source only to apply energy to portions of build material on which coalescing agent has been applied.

In further examples, the energy source 226 may be a focused energy source, such as a laser beam. In this example the laser beam may be controlled to scan across the whole or a portion of a layer of build material. In these examples the laser beam may be controlled to scan across a layer of build material in accordance with agent delivery control data, For example, the laser beam may be controlled to apply energy to those portions of a layer of on which coalescing agent is delivered.

The combination of the energy supplied, the build material, and the coalescing agent may be selected such that, excluding the effects of any coalescence bleed: i) portions of the build material on which no coalescing agent have been delivered do not coalesce when energy is temporarily applied thereto; ii) portions of the build material on which only coalescing agent has been delivered or has penetrated coalesce when energy is temporarily applied thereto do coalesce.

The system 200 may additionally include a heater 230 to emit heat to maintain build material deposited on the support 204 within a predetermined temperature range. The heater 230 may have any suitable configuration. One example is shown in FIG. 2, which is a simplified isometric illustration of a heater 230 for an additive manufacturing system according to some examples. The heater 230 may have an array of heating units 232, as shown in FIG. 2. The heating units 232 may be each be any suitable heating unit, for example a heat lamp such as an infra-red lamp. The heating units 232 may have any suitable shapes or configurations such as rectangular as shown in FIG. 2. In other examples they may be circular, rod shaped, or bulb shaped, for example. The configuration may be optimized to provide a homogeneous heat distribution toward the area spanned by the build material, Each heating unit 232, or groups of heating units 232, may have an adjustable current or voltage supply to variably control the local energy density applied to the build material surface.

Each heating unit 232 may correspond to its own respective area of the build material, such that each heating unit 232 may emit heat substantially toward its own area rather than areas covered by other heating units 232. For example, each of the sixteen heating units 232 may heat one of sixteen different areas of the build material, where the sixteen areas collectively cover the entire area of the build material. However, in some examples, each heating unit 232 may also emit, to a lesser extent, some heat which influences an adjacent area.

In some examples, additionally or alternatively to the heater 230, a heater may be provided below the platen of the support member 204 to conductively heat the support member 204 and thereby the build material. The conductive heater may be to uniformly heat the build material across its area on the support member 204.

The system 200 may additionally include sensors 228a-b which may be to detect radiation or acoustic waves, for example. The sensors 228a-b may be oriented generally centrally and facing generally directly toward the build material, such that the optical axis of the camera targets the center line of the support member 204, to allow a generally symmetric capture of radiation or acoustic waves from the build material. This may minimize perspective distortions of the build material surface, thus minimizing the need for corrections. Additionally, the sensor 228a-b may, for example, be to (1) capture radiation or acoustic waves over a wide region covering an entire layer of build material, for example by using suitable magnification, (2) capture a series of measurements of the entire layer which are later averaged, or (3) capture a series of measurements each covering a portion of the layer that together cover the entire layer. In some examples, the sensors 228a-b may be in fixed locations relative to the support member 204, but in other examples may be moveable if other components, when moving, disrupt the line of sight between the sensors 228a-b and the support member 204.

In some examples, each of the sensors 228a-b may comprise an array of sensors. Each of the sensors in the array may correspond to its own respective area of the build material, such that each sensor in the array may perform measurements on its own area rather than areas corresponding to other sensors in the array. The array of sensors 228a may collectively cover the entire area of the build material. Similarly, the array of sensors 228b may collectively cover the entire area of the build material. In some examples, both radiation and acoustic sensors may be used.

In some examples, the sensor 228a may, for example, be a point contactless temperature sensor such a thermopile, or such as a thermographic camera. In other examples, the sensor 228a may include an army of fixed-location pyrometers which each capture radiation from a single area of the build material. In other examples, the sensor 228a may be a single pyrometer which may be operable to sweep or scan over the entire area of the build material. Any other type of sensors may also be used that may be suitable for a determination of temperature of build material. The sensor 228a may be to capture a radiation distribution, for example in the IR range, emitted by each point of the build material across the area spanned by the build material on the support member 204. The temperature sensor 228a may output the radiation distribution to the controller 210, which may determine a temperature distribution across the build material based on known relationships, such as a black body distribution, between temperature and radiation intensity for the material used as the build material. For example, the radiation frequencies of the radiation distribution may have their highest intensities at particular values in the infra-red (IR) range. This may be used to determine the temperature distribution comprising a plurality of temperatures across the build material. In some examples, rather than the overhead configuration of the sensor 228a as shown in FIG. 2, the sensor 228a may be located in any other suitable location in the system 200, for example it may be coupled to the support member 204.

In some examples, the sensor 228b may be any sensor suitable to detect a height profile of build material. In some examples, the sensor 228b may be a ranging sensor, and may comprise, for example, an acoustic sensor, diode emitter, radar, IR, or any other ranging sensor. The ranging sensor may be to determine the time of flight of an acoustic wave or radiation emitted from the sensor 228b and then detected by the sensor 228b after reflection by the build material. However, sensors other than ranging sensors may be used to detect a height profile of the build material. In some examples, rather than the overhead configuration of the sensor 228b as shown in FIG. 2, the sensor 228b may be located in any outer suitable location in the system 200, for example it may be coupled to the support member 204.

The controller 210 may obtain or generate agent delivery control data which may define for each slice of the three-dimensional object to be generated the portions or the locations on the build material, if any, at which agent is to be delivered. The agent delivery control data may be stored as part of the instructions 218.

In some examples, the agent delivery control data may be generated based on object design data representing a three-dimensional model of an object to be generated, and/or from object design data representing properties of the object. The model may define the solid portions of the object, and may be processed by the three-dimensional object processing system to generate slices of parallel planes of the model. Each slice may define a portion of a respective layer of build material that is to be solidified by the additive manufacturing system. The object property data may define properties of the object such as density, surface roughness, strength, and the like.

The object design data and object property data may be received, for example, from a user via an input device 220, as input from a user, from a software driver, from a software application such as a computer aided design (CAD) application, or may be obtained from a memory storing default or user-defined object design data and object property data.

The agent delivery control data may describe, for each layer of build material to be processed, locations or portions on the build material at which coalescing agent is to be delivered. In one example the locations or portions of the build material at which coalescing agent is to be delivered are defined by way of respective patterns.

FIG. 3 is a flow diagram illustrating a method 300 of generating a three-dimensional object according to some examples. in some examples, the orderings shown may be varied, some elements may occur simultaneously, some elements may be added, and some elements may be omitted.

In describing FIG. 3, reference will be made to FIGS. 2, 4a-h, 5a-d, 6a-e, and 7a-c. FIGS. 4a-h show a series of cross-sectional side views of layers of build material according to some examples. FIGS. 5a-d, 6a-e, and 7a-c show a series of cross-sectional side views of layers of build material and build material distributors in which corrective actions are performed according to some examples,

At 302, data representing the three dimensional object may be generated or obtained by the controller 210. Data representing the three dimensional object” is, defined herein to include any data defining the object from, e.g. its initial generation as a three dimensional object model, to its conversion into slice data, and to its conversion into a form suitable for controlling an agent distributor such as agent delivery control data. Such data is also defined to include data used an agent distributor to define which nozzles of an agent distributor to use,

At 304, a layer 402b of build material may be provided, as shown in FIG. 4b. For example, the controller 210 may control the build material distributor 224 to provide the layer 402b on a previously completed layer 402a (completed e.g. at FIG. 4a) on the support member 204 by causing the build material distributor 224 to move along the x-axis as discussed earlier. The completed layer 402a may include a solidified portion 406. Although a completed layer 402a is shown in FIGS. 4a-h for illustrative purposes, it is understood that 304 to 330 may initially be applied to generate the first layer 402a.

In the example of FIGS. 4b, example defects 410, 412, and 414 of build material are shown. In some examples, the defects may be caused by errors in any element of method 300 including delivery of build material, heating of build material, delivery of agents to build material, and/or application of energy to build material. In some examples, the defects may be caused by a malfunction of any of the components of the system 200 described earlier relative to FIG. 2 as well as other components not shown. Defect 410 is an accumulation of build material on the layer 402b, defect 412 is a hole in the layer 402b, and defect 414 is an accumulation of build material on the build material distributor 224. Defects 410, 412, and 414 may result from e.g. an error during distribution of build material at 304 by the build material distributor 224. In various examples, FIG. 5a shows layer 402b having defect 410, FIG. 6a shows layer 402b having defect 412, and FIG. 7a shows build material distributor 224 having defect 414.

At 306, a determination may be made regarding whether a defect exists in the build material, e.g. in layer 402b, in the object being generated, and/or on the build material distributor 224.

The sensor 228a may detect a property, e,g. emitted radiation, of the build material used for a determination of temperature, and the sensor 228b may detect a height profile of build material e.g. configuration or shape of build material (such detection may involve detecting time of flight of radiation or acoustic waves). Data from the sensors 228a-b may be received by the controller 210.

In some examples, if the sensor 228a is a ranging sensor, the data from sensor 228b may represent a longer time of flight of an acoustic wave or radiation used for detection than expected in the location of the hole defect 410. In other examples, the data may represent other properties associated with a height profile of the hole defect 410. Thus, based on the data, the controller 210 or a processor in the sensor 228b may determine that the defect 410 is a hole in the layer 402b.

In some examples, if the sensors 228b is a ranging sensor, the data from the sensor 228b may represent a shorter time of flight of an acoustic wave or radiation used for detection than expected in the respective locations of the defect 412 and/or defect 414. In other examples, the data may represent other properties associated with a height profile of the accumulation defects 412 and/or 414. Thus, based on the data, the controller 210 or a processor in the sensor 228b may determine that the defect 412 is an accumulation of build material on the layer 402a and/or that the defect 414 is an accumulation of build material on the build material distributor 224.

In some examples, the data from the sensor 228a may represent a property associated with a temperature of the layer 402b. For example, if the sensor 228a is a radiation sensor, the data from the sensor 228a may represent an emitted radiation distribution that, due to the defects 410 and/or 412, varies from an expected radiation distribution emitted from the layer 402b, wherein the expected radiation distribution is a distribution that would result from expected build material processing during generation of the object (e.g. expected delivery of build material, expected coalescence and solidification of build material, etc.). Thus, based on the data, the controller 210 or a processor in the sensor 228a may determine that the defect 410 is an hole in the layer 402a and/or that the defect 412 is an accumulation of build material on the layer 402b.

In some examples, data from the sensor 228a may be used to determine whether a defect is present. In some examples, data from the sensor 228b may be used to determine whether a defect is present. In some examples, a combination of data from the sensor 228a and the sensor 228b may be used to determine whether a defect is present.

At 308, if a defect exists (e.g. defects 410, 412, and/or 414), then the method 300 may proceed to 310, otherwise the method 300 may proceed to 312.

At 310, an action may be taken in response to the defect existing. For example, the controller 210 may instruct the system 200 to take an action to correct the defect, or the controller 210 may instruct the system 200 to take an action to prevent the system 200 from being damaged due to the defect.

Examples of actions to correct the hole defect 410 are shown in FIGS. 5b-d.

As shown in FIG. 5b, the build material distributor 224 may be to deliver an additional layer of build material to fill the hole defect 410. In some examples, the controller 210 may determine a sufficient amount of build material may be delivered to fill the hole defect 410 but e.g. such that the overall thickness of layer 402b is not increased or is minimally increased. In some examples, although not shown, the build material distributor 224 may pass across the layer 402b to level the layer 420b without adding any additional build material. In some examples, a combination of leveling and build material delivery may be performed.

As shown in FIG. 5c, the leveling tool 234 may be to level the layer 402b as described earlier, for example by vibrating the support member 204 or tilting the support member 204 in opposing directions until the layer 402b is sufficiently leveled as shown in FIG. 5c.

As shown in FIG. 5d, energy and/or heat selectively or unselectively applied by the energy source 226 and/or the heater 230 may be used to regulate the temperature in portions of the layer 402b. In some examples, the object being generated may, as a result of unintended temperature distributions and irregularities in the build material, experience bending, coalescence bleed wherein portions of build material experience coalescence unintentionally, or deformations. This may result in hole defect 410. Accordingly, in some examples, the application of energy and/or heat may be performed at 310 to modulate the temperature distributions such that they achieve values to compensate for and correct the defect 410. For example, the temperature distribution may be selected to cause thermal gradients which expand the build material in the region of the defect 410, and/or cause shrinkage in adjacent portions of build material. In some examples, the application of heat and/or energy may also be modulated to achieve such effects at 312 and/or at 324 when the energy source 226 and/or heater 230 are actuated for the build process.

Examples of actions to correct the accumulation defect 412 are shown in FIGS. 6b-d. An example of an action to prevent the system 200 from being damaged due to the accumulation defect 410 is shown in FIG. 6e.

As shown in FIG. 6b, the build material distributor 224 may pass across the layer 402b to level the layer 420b without adding any additional build material. In some examples, although not shown, the build material distributor 224 may additionally deliver an additional layer of build material to cover the accumulation defect 412. In some examples, the controller 210 may determine a sufficient amount of build material may be delivered to cover the accumulation defect 410 but e.g. such that the overall thickness of layer 402b is minimally increased. In some examples, a combination of leveling and build material delivery may be performed.

As shown in FIG. 6c, the leveling tool 234 may be to level the layer 402b as described earlier, for example by vibrating the support member 204 or tilting the support member 204 in opposing directions until the layer 402b is sufficiently leveled as shown in FIG. 6c.

As shown in FIG. 6d, energy and/or heat selectively or unselectively applied by the energy source 226 and/or the heater 230 may be used to regulate the temperature in portions of the layer 402b. In some examples, the object being generated may, as a result of unintended temperature distributions and irregularities in the build material, experience bending, coalescence bleed wherein portions of build material experience coalescence unintentionally, or deformations. This may result in accumulation defect 412. Accordingly, in some examples, the application of energy and/or heat may be performed at 310 to modulate the temperature distributions such that they achieve values to compensate for and correct the defect 412. For example, the temperature distribution may be selected to cause thermal gradients which shrink the build material in the region of the defect 412, and/or cause expansion in adjacent portions of build material. In some examples, the application of heat and/or energy may also be modulated to achieve such effects at 312 and/or at 324 when the energy source 226 and/or heater 230 are actuated for the build process.

As shown in FIG. 6e, the system 200 may be prevented from being damaged due to the accumulation defect 412 by preventing actuation or usage of a component of the system 200 (e.g. the build material distributor 224 in FIG. 6e), and/or by stopping the build process for generating the object. This may be done, for example, if the accumulation defect 412 may impact (e.g. crash into) a component (e.g. an agent distributor) of the system 200 and become damaged during the build process if the component is not prevented from actuating or being used.

An example of an action to prevent the system 200 from being damaged due to the accumulation defect 414 is shown in FIG. 7b. An example of an action to correct the accumulation defect 414 is shown in FIG. 7c.

As shown in FIG. 7b, the system 200 may be prevented from being damaged due to the accumulation defect 414 by preventing actuation or usage of a component of the system 200 (e.g, the build material distributor 224 in FIG. 7b), and/or by stopping the build process for generating the object. This may be done, for example, if the accumulation defect 414 may impact (e.g. crash into) a component (e.g. an agent distributor) of the system 200 and become damaged during the build process if the component is not prevented from actuating or being used.

As shown in FIG. 7c, the build material distributor 224 may be moved to be stationed at the cleaning station 236 which may use suitable components to clean the accumulation 414 off of the build material distributor 224.

Although 306 to 310 are shown as occurring after providing each layer of build material, they may occur at any time, periodically, and/or continuously throughout the build process. In the example of FIG. 3, for illustrative purposes, similar elements 318 to 322 and 326 to 330 are shown.

At 312, the layer 402b of build material may be heated by the heater 230 to heat and/or maintain the build material within a predetermined temperature range. The predetermined temperature range may, for example, be below the temperature at which the build material would experience bonding in the presence of coalescing agent 404. For example, the predetermined temperature range may be between about 155 and about 160 degrees Celsius, or the range may be centered at about 160 degrees Celsius, Pre-heating may help reduce the amount of energy that has to be applied by the energy source 226 to cause coalescence and subsequent solidification of build material on which coalescing agent has been delivered or has penetrated.

In some examples, as discussed earlier, the application of heat may also be modulated to achieve temperature regulation effects for correcting defects 410 and 412 in addition to usage of the heater 230 for pre-heating the layer 402b.

At 314, as shown in FIG. 4d, coalescing agent 404 may be selectively delivered to the surface of portions of the layer 402b. As discussed earlier, the agent 404 may be delivered by agent distributor 202, for example in the form of fluids such as liquid droplets.

The selective delivery of the agent 404 may be performed in patterns on the portions of the layer 402b that the data representing the three-dimensional object may define to become solid to form part of the three-dimensional object being generated. The data representing the three-dimensional object may be unmodified data if a dead zone was not identified and modified data if a dead zone was identified. “Selective delivery” means that agent may be delivered to selected portions of the surface layer of the build material in various patterns.

In some examples, binder agent may be used rather than coalescing agent. Thus, the term “agent” is understood to encompass both coalescing agent and binder agent.

In some examples, coalescence modifier agent may similarly be selectively delivered to portions of the layer 402b.

FIG. 4e shows coalescing agent 404 having penetrated substantially completely into the portions of the layer 402b of build material, but in other examples, the degree of penetration may be less than 100%. The degree of penetration may depend, for example, on the quantity of agent delivered, on the nature of the build material, on the nature of the agent, etc.

In the example of FIG. 4e, for illustrative purposes, additional instances of hole defect 410 and accumulation defects 412 and 414 are shown similar the defects 410, 412, and 414 shown in FIG. 4b, These additional instances may have been caused by any element of method 300 and/or by malfunction of any component of system 200 or other component, as described earlier. Although the defects 410 and 412 of FIG. 4e are shown in portions of the layer 402b having coalescing agent 404, they may also be present in portions of layer 402b lacking coalescing 404.

At 318, a determination may be made regarding whether a defect exists in the build material, e.g. in layer 402b, in the object being generated, and/or on the build material distributor 224. This may be done in a similar way as described earlier relative to 306.

At 320, if a defect exists (e.g. defects 410, 412, and/or 414), then the method 300 may proceed to 322, otherwise the method 300 may proceed to 324.

At 322, an action may be taken in response to the defect existing. For example, the controller 210 may instruct the system 200 to take an action to correct the defect, or the controller 210 may instruct the system 200 to take an action to prevent the system 200 from being damaged due to the defect. This may be done in a similar way as described earner relative to 310.

At 324, a predetermined level of energy may be temporarily applied to the layer 402b of build material. In various examples, the energy applied may be infra-red or near infra-red energy, microwave energy, ultra-violet (UV) light, halogen light, ultra-sonic energy, or the like. The temporary application of energy may cause the portions of the build material on which coalescing agent 404 was delivered to heat up above the melting point of the build material and to coalesce. In some examples, the energy source 226 may be focused, In some examples in which the energy source 226 is focused, the energy source 226 may cause coalescence of build material without use of coalescing agent 404, but in other examples coalescing agent 404 may be used. In other examples, the energy source 226 may be unfocused, and the temporary application of energy may cause the portions of the build material on which coalescing agent 404 has been delivered or has penetrated to heat up above the melting point of the build material and to coalesce. For example, the temperature of some or all of the layer 402b may achieve about 220 degrees Celsius. Upon cooling, the portions having coalescing agent 404 may coalesce may become solid and form part of the three-dimensional object being generated, as shown in FIG. 4g.

As discussed earlier, one such solidified portion 406 may have been generated in a previous iteration, The heat absorbed during the application of energy may propagate to the previously solidified portion 406 to cause part of portion 406 to heat up above its melting point. This effect helps creates a portion 408 that has strong interlayer bonding between adjacent layers of solidified build material, as shown in FIG. 4g.

In some examples, as discussed earlier, the application of energy may also be modulated to achieve temperature regulation effects for correcting defects 410 and 412 in addition to usage of the energy source 226 for coalescence and solidification of portions of the layer 402b.

In some examples, the energy may not be applied, for example if binder agent is used, or if the coalescing agent 404 is to cause coalescence and solidification of build material without use of the energy source 226.

In the example of FIG. 4g, for illustrative purposes, additional instances of hole defect 410 and accumulation defects 412 and 414 are shown similar the defects 410, 412, and 414 shown in FIGS. 4b and 4e. These additional instances may have been caused by any element of method 300 and/or by malfunction of any component of system 200 or other component, as described earlier. Although the defects 410 and 412 of FIG. 4g are shown in solidified portions of the layer 402b, they may also be present in unsolidified portions of layer 402b.

At 326, a determination may be made regarding whether a defect exists in the build material, e.g. in layer 402b, in the object being generated, and/or on the build material distributor 224. This may be done in a similar way as described earlier relative to 306.

At 328, if a defect exists (e.g. defects 410, 412, and/or 414), then the method 300 may proceed to 330, otherwise the method 300 may proceed to 304.

At 330, an action may be taken in response to the defect existing. For example, the controller 210 may instruct the system 200 to take an action to correct the defect, or the controller 210 may instruct the system 200 to take an action to prevent the system 200 from being damaged due to the defect. This may be done in a similar way as described earlier relative to 310.

After a layer of build material has been processed as described above in 304 to 330, new layers of build material may be provided on top of the previously processed layer of build material. In this way, the previously processed layer of build material acts as a support for a subsequent layer of build material. The process of 304 to 330 may then be repeated to generate a three-dimensional object layer by layer.

All of the features disclosed in this specification (including any accompanying claims, abstract and drawings), and/or all of the elements of any method or process so disclosed, may be combined in any combination, except combinations where at least some of such features and/or elements are mutually exclusive.

In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

1. A system for generating a three-dimensional object, the system comprising:
a sensor to detect a height profile of build material for generating the three-dimensional object; and
a controller to:
determine that a defect of the build material exists based on data received from the sensor and relating to the height profile of the build material;
instruct the system to correct the defect or to prevent the defect from impacting a component of the system; and
control the system to selectively solidify a portion of a layer of the build material delivered by a build material distributor.

2. The system of claim 1 wherein the controller is to instruct the system to correct the defect.

3. The system of claim 1 wherein the defect is an accumulation of the build material on the build material distributor or on the layer of build material delivered by the build material distributor, wherein the controller is to instruct the system to prevent the defect from impacting a component of the system.

4. The system of claim 1 wherein the defect is an accumulation of the build material on the layer of build material delivered by the build material distributor.

5. The system of claim 4 further comprising a build material distributor to deliver, on a support member, the layer of the build material, and to level the layer of the build material, wherein the controller is to instruct the system to correct the defect by controlling the build material distributor to level the layer of the build material.

6. The system of claim 4 further comprising a vibrating tool to vibrate the layer of the build material to level the accumulation of the build material, wherein the controller is to instruct the system to correct the defect by controlling the vibrating tool to vibrate the layer of the build material to level the accumulation of the build material.

7. The system of claim 1 wherein the defect is a hole in a layer of the build material delivered by a build material distributor.

8. The system of claim 7 further comprising a build material distributor to deliver, on a support member, the layer of the build material, and to fill the hole in the layer of the build material, wherein the controller is to instruct the system to correct the defect by controlling the build material distributor to fill the hole in the layer of the build material.

9. The system of claim 7 further comprising a vibrating tool to vibrate the layer of the build material to level the layer of the build material, wherein the controller is to instruct the system to correct the defect by controlling the vibrating tool to vibrate the layer of the build material to level the layer of the build material.

10. The system of claim 1 further comprising a build material distributor to deliver, on a support member, the layer of the build material, wherein the defect is an accumulation of the build material on the build material distributor,

11. The system of claim 1 further comprising a cleaning station to clean the accumulation of the build material off of the build material distributor, wherein the controller is to instruct the system to correct the defect by moving the build material distributor to the cleaning station to allow the accumulation to be cleaned manually or automatically using the cleaning station.

12. The system of claim 1 further comprising a second sensor to detect a property associated with a temperature of the build material, wherein the defect is an accumulation of the build material on the layer of build material delivered by the build material distributor or is a hole in the layer of build material delivered by the build material distributor, wherein the determination that the defect exists is further based on second data received from the second sensor and relating to the property of the build material.

13. The system of claim 12 wherein the controller is to instruct the system to correct the defect by heating the layer of build material using a heater or by applying energy to the layer of build material using an energy source.

14. A method comprising:
detecting, by a sensor, a shape or configuration of build material for generating a three-dimensional object;
determining, by a controller, that a defect of the build material exists based on the detected shape or configuration of the build material;
delivering, by a build material distributor, a layer of build material, the delivered layer of build material being selectively solidifiable by delivery of agent or by application of energy thereto; and
correcting the defect or preventing the defect from impacting a component of the system.

15. A non-transitory computer readable storage medium including executable instructions that, when executed by a processor, cause the processor to:
control a ranging sensor to detect a height profile of build material for generating a three-dimensional object;
receive data relating to the detected height profile of the build material from the ranging sensor;
based on the received data, determine that the build material includes an accumulation or a hole;
control a system for generating the three-dimensional object to correct the accumulation or the hole or control the system to prevent the accumulation from impacting a component of the system;
control the system to selectively solidify a portion of a layer of the build material delivered by a build material distributor.
